(19) United States
(12) Patent Application Publication
(10) Pub. No.: US 2005/0119899 A1
(43) Pub. Date: Jun. 2, 2005

(54) Phrase constructor for translator

(76) Inventor: Robert D. Palmquist, Faribault, MN (US)

Correspondence Address: SHUMAKER & SIEFFERT, P. A., 8425 SEASONS PARKWAY, SUITE 105, ST. PAUL, MN, 55125, US

(21) Appl. No.: 10/988,200

(22) Filed: Nov. 12, 2004

Related U.S. Application Data
(60) Provisional application No. 60/520,480, filed on Nov. 14, 2003.

(51) Int. Cl. G06F 17/20; G10L 21/00

(52) U.S. Cl. 704/277; 704/1

(57) ABSTRACT

In general, the invention is directed to techniques for finding and constructing phrases for translation. In an exemplary embodiment, a hand-held device that acts as an electronic phrase book implements the techniques of the invention. The device presents the user with a menu of object words and receives the user's selected object word. The device presents a menu of phrases that include the object word in context, and receives the selected phrase. The device may further present the user with a menu of modifiers that further refine the meaning of the phrase, and receive a selected modifier. In this way, the user quickly constructs a phrase of interest. The device translates the phrase, and presents the user with the translation.

This application claims the benefit of U.S. Provisional Application Ser. No. 60/520,480, filed Nov. 14, 2003, the entire content of which is incorporated herein by reference.

### TECHNICAL FIELD

The invention relates to electronic data management, and more particularly, to electronic data management of phrases used for translation.

### BACKGROUND

The need for language translation tools has become increasingly important. It is becoming more common for a person to encounter foreign language text. Trade with a foreign company, cooperation of forces in a multi-national military operation in a foreign land, emigration and tourism are just some examples of situations that bring people in contact with languages with which they may be unfamiliar.

One conventional approach to overcoming a language barrier is the use of a phrase book. A typical phrase book organizes phrases according to general subjects, such as “Purchasing,” “Restaurants” or “At the Doctor,” and includes a list of standard phrases pertinent to the general subject. It is not unusual for several dozen phrases to be present, and a user may have to scan several phrases to find the phrase of interest.

In some circumstances, such as a medical emergency, finding a phrase of interest quickly is a matter of considerable importance. In other circumstances, finding a phrase of interest quickly is a matter of convenience and good manners.

### SUMMARY

In general, the invention is directed to techniques for finding and constructing phrases for translation. In an exemplary embodiment, the techniques are implemented by a hand-held device that acts as an electronic phrase book.

In one embodiment, the invention is directed to a method in which the device presents the user with a menu of object words. Object words are the words that are generally the most important words in the phrase of interest. In many cases, the object words are nouns such as “car,” “aspirin” or “telephone.” The device receives the user's selected object word, and presents a menu of phrases that include the object word in context. The device receives the user's selected phrase. Some phrases may include associated modifiers, and the device may present the user with a menu of modifiers that refine the meaning of the phrase. Modifiers may pertain to matters such as size, shape, quantity, direction, extent, and so forth.

By selection of object words, and phrases that include the object words and modifiers, the user can quickly construct the phrase of interest. The device takes the phrase of interest and translates the phrase, and presents the user with the translation. The translation may be presented in a number of ways, including as text, as phonetic pronunciation, or as audible speech.

In one embodiment, the invention is directed to a method comprising presenting a first menu of object words in a first language and receiving a selection of a particular object word from the first menu. The method also includes presenting a second menu of phrases in the first language, with each phrase in the second menu including the particular object word, and receiving a selection of a particular phrase including the particular object word from the second menu. The method further includes translating the particular phrase to a second language. The method may also include presenting a third menu of modifiers associated with the particular phrase and receiving a selection of a particular modifier from the third menu. The translated phrase may thus include a selected phrase having a selected object word and one or more selected modifiers.

In another embodiment, the invention is directed to a computer-readable media comprising instructions that cause a programmable processor to carry out the methods of the invention.

In a further embodiment, the invention presents a device comprising a phrase constructor and a translator. The phrase constructor presents a first menu of object words in a first language and receives a selection of a particular object word from the first menu. The phrase constructor also presents a second menu of phrases in the first language, each phrase in the second menu including the particular object word, and receives a selection of a particular phrase including the particular object word from the second menu. The translator translates the particular phrase to a second language.

The invention may offer one or more advantages. When embodied in a portable device such as a handheld computer, cell phone or PDA, the invention can serve as a versatile electronic phrase book. By applying phrase construction techniques according to the invention, the user can construct a desired phrase quickly and easily. The construction is easy for the user to follow, and the device assists the user in construction by presenting the selected object word in context with phrases and modifiers. By selection of object words, phrases and modifiers, the user can construct a phrase for translation that conveys the message that the user wishes to convey. The number of phrases that a user can construct is virtually unlimited.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a functional block diagram of a device configured to carry out the techniques of the invention.

FIGS. 2-5 are exemplary screen shots illustrating phrase construction and selection.

FIG. 6 is a flow diagram illustrating phrase construction and translation of the constructed phrase.

### DETAILED DESCRIPTION

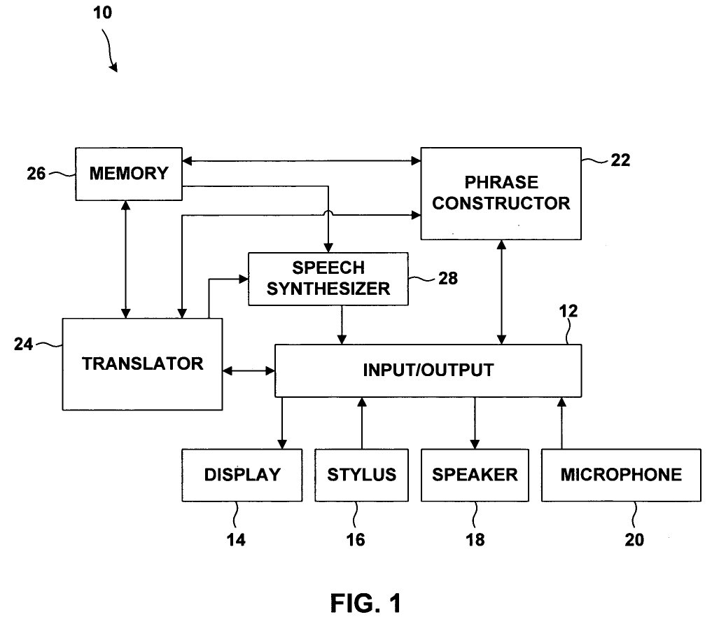

FIG. 1 is a functional block diagram of an exemplary device 10 configured to carry out the techniques of the invention. Although the invention is not limited to a particular device, the invention will be described in the context of a handheld computer, cell phone or personal digital assistant (PDA). Devices of this kind are portable and can interact with a user via any number of input/output devices.

In FIG. 1, the user interacts with device 10 through an input/output interface 12. Input/output interface 12 may support any number of input/output devices, such as a display 14 to display images or text, a stylus 16 to make selections, and a speaker 18 to generate audible output. In some embodiments, device 10 includes a microphone 20 that receives speech from a user and features that support speech recognition. For example, device 10 may include a voice recognition module (not shown) configured to recognize spoken words, spoken spelled words, or words spelled using a phonetic alphabet such as the “Alpha, Bravo, Charlie, Delta” phonetic alphabet, or any combination thereof. Similarly, other embodiments of device 10 may support handwriting recognition. Embodiments of device 10 may also support other input/output devices, such as a touchscreen, keyboard, mouse, arrow keys, or the like.

When the user desires to translate a phrase of interest, the user constructs the phrase of interest by interacting with a phrase constructor 22. Phrase constructor 22 is the logical element that is configured to guide the user through the phrase selection process, as described in detail below. Phrase constructor 22 may be embodied as hardware, software, or a combination of hardware and software.

After the user has selected a phrase for translation using phrase constructor 22, phrase constructor 22 supplies the phrase to a translator 24 for translation. Translator 24, which may be embodied as hardware, software, or a combination of hardware and software, is configured to translate the selected phrase to a desired target language. Translator 24 may be any of several commercially available translator modules.

Memory 26 may store, among other things, vocabulary and grammar to support translator 24. Memory 26 may also store menus of general subjects, object words, phrases, and modifiers used by phrase constructor 22. Memory 26 may be embodied as any form of volatile or non-volatile memory, or any combination thereof.

Although phrase constructor 22 and translator 24 are depicted as distinct elements, the depiction is for purpose of explanation. In one embodiment of the invention, phrase constructor 22 and translator 24 may comprise distinct software instructions that operate on a common processor. The invention is not limited to any particular hardware or software configuration.

Translator 24 supplies the translation to input/output interface 12, which presents the translation to the user. In some embodiments of the invention, the translation may be supplied to a speech synthesizer 28 for generation of an audible spoken translation presented via speaker 18. In other embodiments, a textual translation, phonetic translation or both are presented visually via display 14.

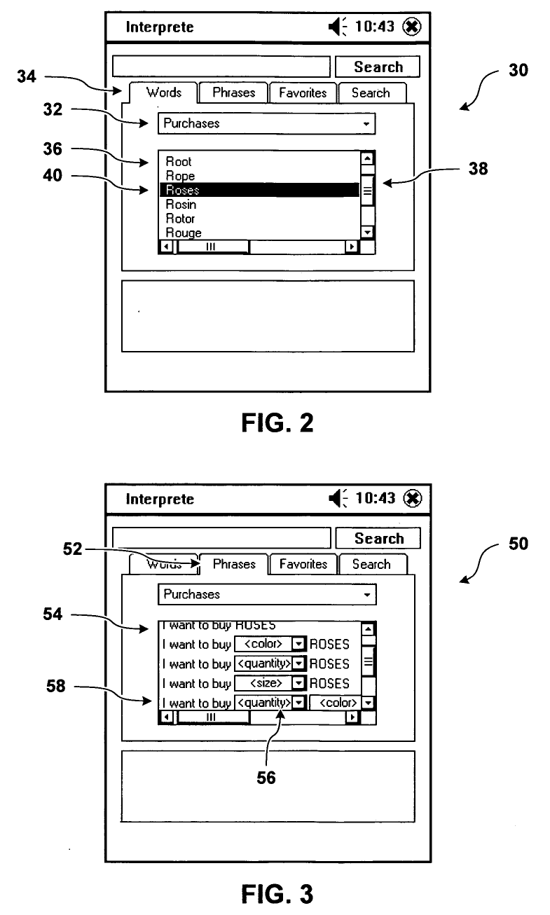

FIG. 2 is an exemplary display 30 that a user may see when constructing a phrase for translation. Suppose the user desires to purchase red roses. The user selects a general subject from a general subject menu 32. In FIG. 2, the general subject is denoted “Purchases.” The user begins phrase construction on with a screen that presents object words, as denoted by a tab 34 denoted “Words.”

The device presents the user with a menu of object words 36. The user may quickly narrow down the list of object words by, for example, touching the first few letters of an object word on a keyboard to bring the desired object word into view, or by using a scroll bar 38, or by touching arrow keys, or by reciting the letters from a phonetic alphabet such as “Romeo, Oscar, Sierra,” or by writing letters with stylus 16 or the like. Upon location of the object word of interest 40, “Roses” in this example, the user selects the particular object word by any selection technique.

Upon receiving the selection of the object word, the device presents the user with a menu of phrases that include the object word, as illustrated in exemplary display 50 in FIG. 3. The phrase menu is identified by a tab 52 denoted “Phrases.” Phrases in the phrase menu 54 include the object word. In exemplary display 50, the object word “ROSES” appears in all capital letters.

Inclusion of the object word in the menu of phrases assists the user in generating the desired phrase in many respects. With the object word included, the phrases are easier for the user to understand, and the user can quickly determine whether an error has been made. Upon seeing a menu of phrases, each phrase including the word “Rope,” for example, the user may select “Words” tab 34 and select the desired object word, “Roses.” In addition, inclusion of the object word in the menu of phrases helps the user identify which phrases make more sense or which phrase more correctly conveys the meaning the user intends to convey.

Some of the phrases include a generic modifier 56 associated with the phrase, with labels such as “<color>,” “<quantity>” and “<size>.” The labels themselves are not modifiers and do not become part of the particular phrase that the user constructs. Rather, the labels denote pull-down menus of words that can modify the phrase to refine the user's desired phrase and more accurately convey the intended message. Modifiers may be any words that refine the meaning that the user intends to convey, and may pertain to matters such as size, shape, quantity, direction, extent, and the like.

Some of the phrases may include more than one modifier 56. Phrase 58, for example, includes a “<quantity>” modifier and a “<color>” modifier. If it were the desire of the user to specify a particular quality and a particular color in a single sentence, such as “I want to buy twelve red roses,” the user may select the phrase that includes both modifiers.

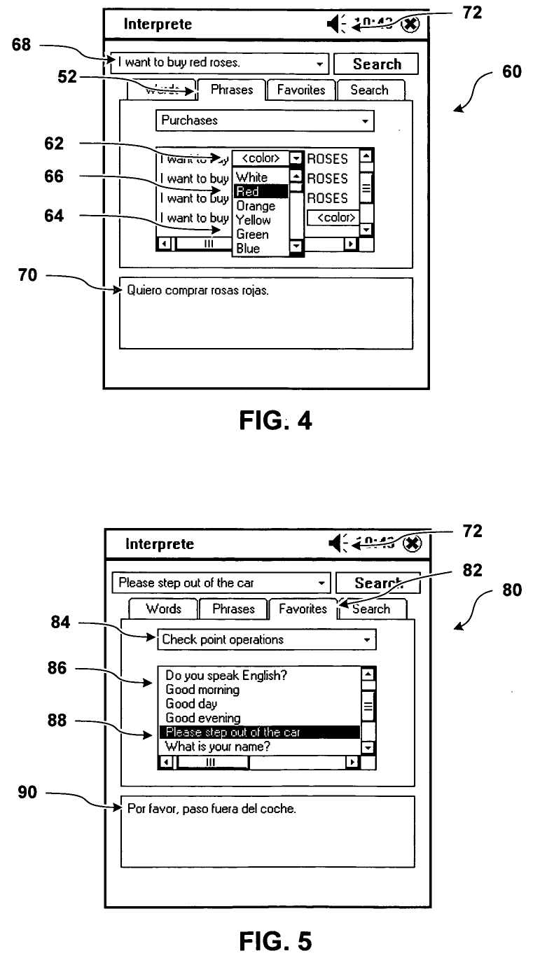

FIG. 4 is an exemplary display 60 depicting selection of a modifier. The user, desiring to buy red roses, has selected a particular phrase from the menu that includes the “<color>” modifier 62. Selection of the “<color>” modifier 62 causes a drop-down menu 64 to appear listing a selection of modifiers, in particular, colors. The user selects the particular modifier of interest 66, “Red.”

The user is presented with the constructed phrase 68, “I want to buy red roses,” and a translation 70 of the phrase. In the example shown in FIG. 4, translation 70 is in Spanish: “Quiero comprar rosas rojas.” Translation 70 not only includes translations of the words, but also proper grammar. As illustrated by FIG. 4, the constructed phrase presents the modifier before the object word, as is proper in English, but translated phrase 70 presents the modifier after the object word, as is proper in Spanish.

In some embodiments of the invention, the user may select an audible option 72, which causes the translated phrase to be spoken. Speech synthesizer 28 may employ any of a number of techniques to generate of an audible spoken translation. In one embodiment of the invention, some words stored in memory 26 include an associated audio file, such as a .wav file, that includes a recorded spoken version of the word. In the event a word includes an associated recorded version, speech synthesizer 28 uses the recording. In the event the recorded version of the word is not stored in memory 26, speech synthesizer 28 generates a synthesized spoken version of the word using conventional voice synthesis techniques, such as the application of letter-to-sound mapping.

In this way, through a selection of object words, phrases that include the object words, and modifiers, the user can quickly select a phrase for translation. In addition, these techniques empower the user to generate millions of distinct phrases. In other words, a device employing the techniques of the invention is more versatile than a conventional phrase book, and empowers the user to convey the desired message with precision.

As shown in exemplary display 80 in FIG. 5, the device can also operate as a conventional electronic phrase book and word look-up dictionary. A user may find that certain words or phrases recur often, and may construct one or more lists of recurring phrases, identified by a tab 82 denoted “Favorites.” The user may select a general subject 84. In exemplary display 80, the general subject is “Check point operations,” which may be a general subject of interest to law enforcement personnel at a border.

Upon selection of a general subject, the user is presented with a menu of pre-constructed phrases or words 86. In this regard, “pre-constructed” means that the words or phrases need not be constructed with phrase constructor 22. Upon selection of a word or phrase of interest 88, the device presents the user with a translation. In one embodiment of the invention, a translation for each pre-constructed phrase or word in the “Favorites” menu is stored in memory 26, and the translation may be recalled from memory 26. In other words, a translation need not be generated anew with translator 24.

The use of a “Favorites” menu may, in some circumstances, be quicker than constructing the phrase with phrase constructor 22. Also, phrases stored in the “Favorites” list may be stored in memory 26 with an audio file that includes a recorded spoken version of the selected phrase. For some languages, a recorded spoken version of the phrase may be more reliable, more understandable, or otherwise more desirable than a spoken version generated with speech synthesizer 28.

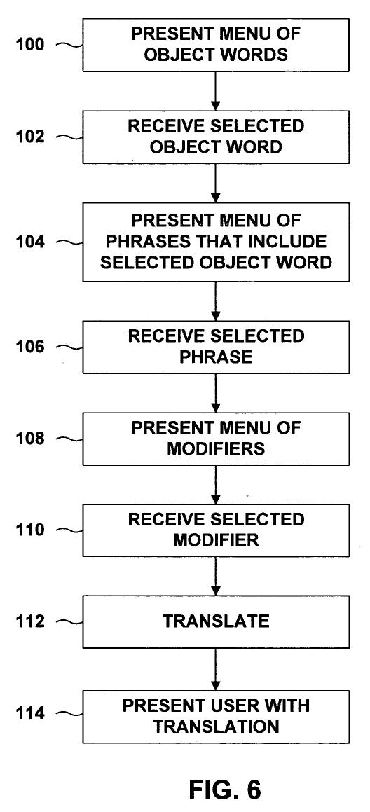

FIG. 6 is a flow diagram illustrating the techniques of the invention. A device such as a handheld computer presents a user with a menu of object words (100). The user selects an object word from the list, and the device receives the selection (102). The device presents the user with a menu of phrases that include the object word (104). The user selects a phrase, and the device receives the selection (106). The device further presents the user with one or more menus of modifiers (108). The user may choose to select a modifier, and the device receives the selection (110).

In this way, the device has helped the user construct a phrase for translation. The device translates the constructed phrase (112) and presents the user with the translation (114). The presentation may be audio or visual or a combination thereof.

The invention may result in one or more advantages. Although the invention is not limited to application on a portable device such as a handheld computer, cell phone or PDA, the invention may be embodied on a portable device and can serve as an electronic phrase book. The phrase construction techniques described herein help the user construct a desired phrase intuitively, quickly and easily. The construction is easy to follow, and the device assists the user in construction by presenting the selected object word in context with phrases and modifiers. By selection of object words, phrases and modifiers, the user can construct a phrase for translation that conveys the message that the user wishes to convey. The number of phrases that a user can construct is virtually unlimited.

Various embodiments of the invention have been described. Various modifications may be made without departing from the scope of the invention. For example, the invention includes devices that can be customized by the user by, for example, adding object words, phrases or modifiers. The invention also encompasses embodiments that include multiple language translators, and that support user selection from a plurality of source and target languages. The invention also includes embodiments with object words and phrases directed to particular fields such as legal, medical or technical disciplines.

The invention is not limited to the particular embodiments described herein. The invention may be embodied, for example, as a computer-readable media comprising instructions for causing a programmable processor to carry out the techniques of the invention. Such computer-readable media include, but are not limited to, magnetic and optical storage media, and read-only memory such as erasable programmable read-only memory or flash memory.

In addition, the invention is not limited to embodiments in which elements depicted in FIG. 1 are embodied in a single device. For example, the invention encompasses embodiments in which two devices cooperate to carry out the techniques of the invention. A user may interact with a cell phone that serves as an input/output device, for example, but phrase construction and translation operations may be carried out by a portable computer in communication with the cell phone. The cell phone and computer may be linked by a physical communications link or may be linked wirelessly. The invention further encompasses embodiments in which cooperating devices are remote from one another, such as an embodiment in which a user's cell phone communicates with a remote computer via a cellular telephone network. These and other embodiments are within the scope of the following claims.

1. A method comprising:
presenting a first menu of object words in a first language;
receiving a selection of a particular object word from the first menu;
presenting a second menu of phrases in the first language, each phrase in the second menu including the particular object word;
receiving a selection of a particular phrase including the particular object word from the second menu; and
translating the particular phrase to a second language.

2. The method of claim 1, further comprising:
presenting a third menu of modifiers associated with the particular phrase; and
receiving a selection of a particular modifier from the third menu.

3. The method of claim 1, further comprising presenting the translation to a user.

4. The method of claim 3, wherein presenting the translation comprises at least one of presenting a textual translation or presenting a phonetic translation.

5. The method of claim 3, wherein presenting the translation comprises presenting an audible translation.

6. The method of claim 5, wherein the translation comprises a plurality of words, and wherein presenting an audible translation comprises presenting a recorded spoken version of a word when the recorded spoken version of the word is stored in memory, and presenting a synthesized spoken version of the word when the recorded spoken version of the word is not stored in memory.

7. The method of claim 1, further comprising:
presenting a third menu, the third menu comprising at least one of a word or a pre-constructed phrase in the first language;
receiving a selection from the third menu; and
presenting a translation of the selection from the third menu in the second language.

8. A computer-readable medium comprising instructions that cause a programmable processor to:
present a first menu of object words in a first language;
receive a selection of a particular object word from the first menu;
present a second menu of phrases in the first language, each phrase in the second menu including the particular object word;
receive a selection of a particular phrase including the particular object word from the second menu; and
translate the particular phrase to a second language.

9. The medium of claim 8, the instructions further causing the processor to:
present a third menu of modifiers associated with the particular phrase; and
receive a selection of a particular modifier from the third menu.

10. The medium of claim 8, the instructions further causing the processor to present the translation to a user.

11. The medium of claim 8, the instructions further causing the processor to:
present a third menu, the third menu comprising at least one of a word or a pre-constructed phrase in the first language;
receive a selection from the third menu; and
present a translation of the selection from the third menu in the second language.

12. A device comprising:
a phrase constructor configured to:
present a first menu of object words in a first language;
receive a selection of a particular object word from the first menu;
present a second menu of phrases in the first language, each phrase in the second menu including the particular object word; and
receive a selection of a particular phrase including the particular object word from the second menu; and
a translator configured to translate the particular phrase to a second language.

13. The device of claim 12, further comprising a speech synthesizer configured to generate an audible version of the translation.

14. The device of claim 12, further comprising a voice recognition module configured to recognize at least one of a spoken word, a spoken spelled word, or a word spelled with a phonetic alphabet.

15. The device of claim 12, further comprising a memory configured to store words in the second language and an associated recorded spoken version of the word.

16. The device of claim 12, further comprising a memory configured to store a set of pre-constructed phrases.
